(19) United States
(12) Patent Application Publication
(10) Pub. No.: US 2003/0183455 A1
(43) Pub. Date: Oct. 2, 2003

(54) Vehicle drive axle oil splasher

(76) Inventors: Mark Schneider, Royal Oak, MI (US); Larry W. Bowman, Troy, MI (US); Eric B. Ratts, Northville, MI (US); Paul Raymond Sieber, Rochester Hills, MI (US); Robert W. Hildebrand, Rochester Hills, MI (US); Michael Everett Johnson, Rochester, MI (US); James R. Brichta, Highland, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/114,207

(22) Filed: Apr. 2, 2002

(51) Int. Cl. F01M 1/00; F16N 7/26

(52) U.S. Cl. 184/11.1

(57) ABSTRACT

A vehicle drive axle is provided that includes a housing having a longitudinal portion defining a cavity. An axle shaft is supported within the cavity for rotation about an axis. The cavity is at least partially filled with oil. A plurality of spaced apart noncontiguous projections extend from the axle shaft in a direction transverse to the rotational axis. During rotation of the axle shafts, the projections extend into the oil within the cavity and splash the oil onto the upper portion of the axle housing. Increased heat dissipation is achieved by dispersing the oil throughout the cavity, and in particular the upper portion of the axle housing, where it radiates into the surrounding environment.

### BACKGROUND OF THE INVENTION

This invention relates to a vehicle drive axle containing oil, and more particularly, the invention relates to an axle shaft having features for dispersing the oil within the axle for increased cooling.

Vehicle drive axles include opposing axle shafts mounted within an axle housing. The axle shafts receive rotational drive from an input such as a drive shaft. The housings is filled with oil, typically up to the center line of the axle shaft, to lubricate the moving parts within the drive axle and cool the axle to maintain the axle within a desired operating temperature.

The temperature of the drive axle may increase during various operating conditions. For example, disc brakes commonly used for retarding and stopping off-road vehicles may generate enormous amounts of heat that may be transmitted to the axle housing and the oil within. To maintain the oil and drive axle at the desired operating temperature, cooling units have been employed to pump oil from the axle housing to a radiator where the oil is cooled and then returned to the axle housing at a lower temperature. Of course, employing a cooling unit having a pump, hydraulic lines and radiator adds cost and complexity to the vehicle. Axle shafts have incorporated features to move the oil along the length of the housing to a desired location. However, these axles have only been concerned with achieving lower temperatures at the desired location and not the overall temperature of the axle. Therefore, what is needed is a drive axle cooling mechanism that obviates the need for an external cooling unit.

### SUMMARY OF THE INVENTION AND ADVANTAGES

The present invention provides a vehicle drive axle including a housing having a longitudinal portion defining a cavity. An axle shaft is supported within the cavity for rotation about an axis. The cavity is at least partially filled with oil. A plurality of spaced apart noncontiguous projections extend from the axle shaft in a direction transverse to the rotational axis. During rotation of the axle shafts, the projections extend into the oil within the cavity and splash the oil onto the upper portion of the axle housing. Increased heat dissipation is achieved by dispersing the oil throughout the cavity, and in particular the upper portion of the axle housing, where it radiates into the surrounding environment.

Accordingly, the above invention provides a drive axle cooling mechanism that obviates the need for an external cooling unit.

### BRIEF DESCRIPTION OF THE DRAWINGS

Other advantages of the present invention can be understood by reference to the following detailed description when considered in connection with the accompanying drawings wherein:

FIG. 1 is a cross-sectional view of a steerable vehicle drive axle as the present invention;

FIG. 2 is an enlarged cross-sectional view of the present invention axle shaft;

FIG. 3 is a cross-sectional view of an axle similar to that shown in FIG. 1; and

FIG. 4 is an enlarged view of a portion of the axle shaft shown in FIG. 3.

### DETAILED DESCRIPTION OF THE PREFERRED EMBODIMENT

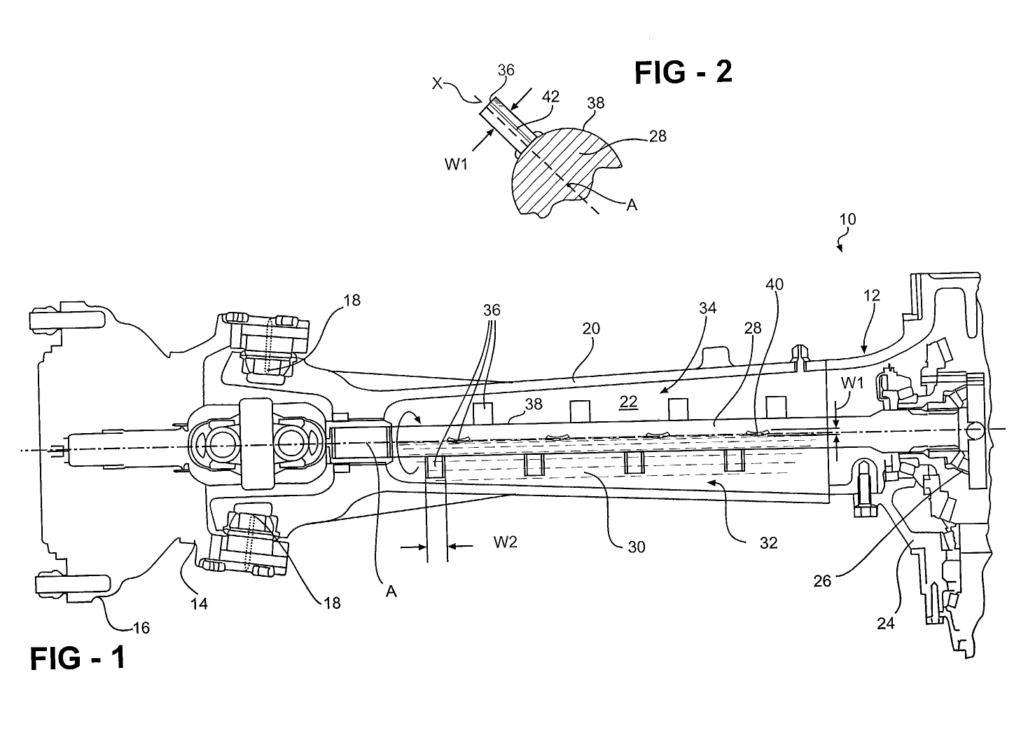

One half of a steerable vehicle drive axle 10 is shown in FIG. 1. The axle 10 includes a housing 12 having opposing ends, only one of which is shown, which support a steering knuckle 14. The steering knuckle 14 supports wheel ends 16 for rotation relative to the housing 12 by king pins 18. The housing 12 has opposing longitudinal portions 20, only one of which is shown, that define a cavity 22. The longitudinal portions 20 are connected by a central portion 24 that houses a differential 26. Opposing axle shafts 28, only one of which is shown, are supported within the cavities 22 and are coupled to the differential 26 to permit relative rotation between the axle shafts 28. As is well known, the differential 26 receives rotational drive from a vehicle drive shaft to rotate the axle shafts 28 about a rotational axis A.

While a steer axle is shown, it is to be understood that the present invention may be used with drive axles other than those which are steerable. Also, it is to be understood that the present invention drive axle need not utilize a differential 26 as shown.

In the prior art, hot oil has typically been cooled to a desired temperature by utilizing a cooling unit that pumps oil from the axle to a radiator where it is cooled and then returned to the axle at a lower temperature. Also, the prior art has utilized augers on the axle shafts to move the oil along the length of the axle. The present invention employs a plurality of spaced-apart noncontiguous projections 36 extending outwardly from the axle shaft 28 to sling or splash oil from a lower portion 32 to an upper portion 34 of the axle housing 12. In this manner, hot oil may be dispersed onto the interior surface of the housing where the heat may be radiated into the surrounding environment to lower the temperature of the oil. The projections 36 may be of any desired shape to minimize the churning losses resulting from the projections as they pass through the oil in the lower portion 32. Furthermore, it is desirable to provide a projection shape that is capable of scooping up the oil 30 and splashing it onto the upper portion 34 of the housing 12. For example, it may be desirable to provide a projection 36 having a first width WI and a second width W2 that is greater than the first width WI. The second width W2 is arranged in a direction parallel to the rotational axis A to scoop the oil 30 from the lower portion 32 and spread it about the interior surface of the cavity 22. The projections 36 may have a concave surface 40, as shown in FIG. 1, or a flat surface 42, as shown in FIG. 2. The features of the projections 36 may be arranged in such a manner so as to orient them in the direction of rotation of the axle shaft 28 about the rotational axis A. For example, as shown in FIG. 1, the concave surface 40 may be arranged such that it scoops the oil 30 during rotation of the axle shaft 28. A projection 36 having a flat surface 42 as shown in FIG. 2 may also be desirable since it need not be arranged in any particular orientation to accommodate a particular direction of rotation.

The projection 36 may be attached to the outer cylindrical surface 38 of the axle shaft 28 by weld beads. The projections 36 may be secured to the axle shaft 28 such that they are at a right angle relative to the outer surface 38 in a direction parallel to the rotational axis A. However, it is to be understood that the projections 36 may be secured to the axle shaft 28 in any desirable orientation. The projections 36 may extend from the outer surface 38 in a direction X that intersects the rotational axis. Furthermore, the projections may be staggered radially about the outer surface 38 and spaced laterally along the length of the axle shaft 28, as shown in FIG. 1.

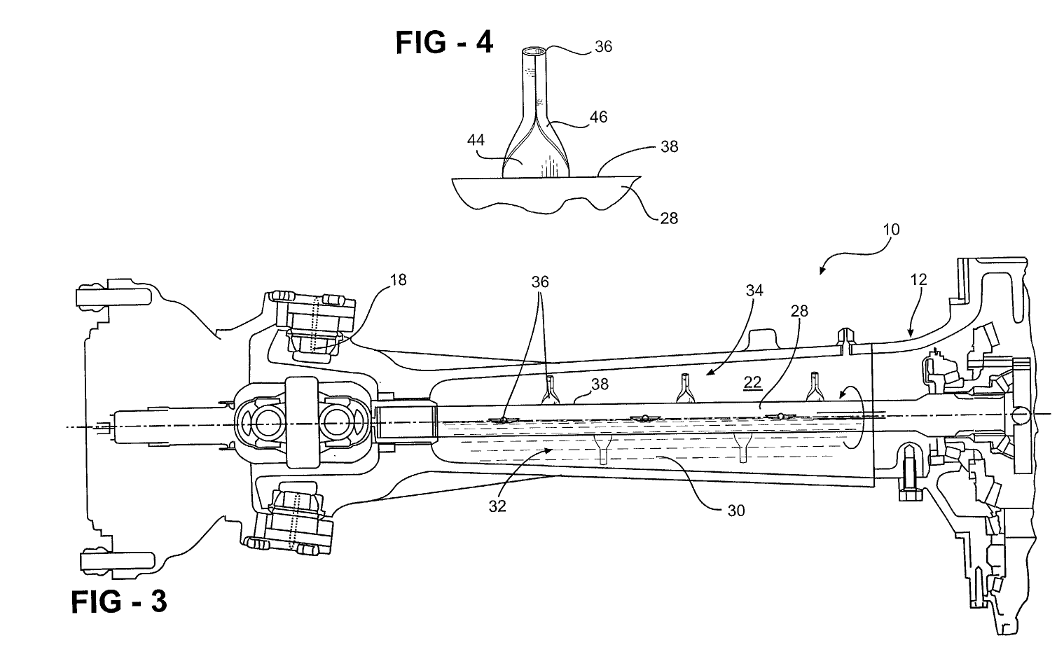

Referring to FIGS. 3 and 4, the projection 36 may include a concave portion 44 adjacent to the outer surface 38 of the axle shaft 28. The concave portion 44 may extend or transition to a tubular portion 46. As the projection 36 moves through the oil 30, oil will be collected by the concave portion 44 and directed through the tubular portion 46 from which the oil 30 is sprayed onto the interior surface of the cavity 22. For additional cooling, the interior surface of the cavity may include a plurality of grooves aligned with the projections 36. As the projections 36 move through the oil 30, oil will be slung from the projections into the grooves. The grooves create additional surface area within the housing 12 and may provide increased cooling.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

What is claimed is:

1. A vehicle drive axle comprising:
a housing having a longitudinal portion defining a cavity;
an axle shaft having a rotational axis supported within said cavity; and
a plurality of spaced apart noncontiguous projections extending from said axle shaft in a direction transverse to said rotational axis.

2. The axle according to claim 1, wherein said housing includes a second longitudinal portion opposite said longitudinal portion defining a second cavity with the axle comprising a second axle shaft coaxial with said rotational axis supported within said second cavity.

3. The axle according to claim 2, further comprising a differential interconnecting said axle shafts permitting relative rotation therebetween about said rotational axis.

4. The axle according to claim 1, wherein said cavity includes upper and lower portions with oil collected in said lower portion and said projections slinging said oil from said lower portion to said upper portion.

5. The axle according to claim 1, wherein said axle shaft includes a generally cylindrical outer surface extending about said rotational axis with said projections extending outwardly from said outer surface.

6. The axle according to claim 5, wherein said projections are arranged generally at a right angle relative to said outer surface in another direction parallel to said rotational axis.

7. The axle according to claim 6, wherein said direction intersects said rotational axis.

8. The axle according to claim 5, wherein projections are staggered radially about said outer surface and spaced laterally in said another direction.

9. The axle according to claim 1, wherein said projections have a first width and a second width greater than said first width with said second width arranged in said another direction.

10. The axle according to claim 1, wherein said projections are flat.

11. The axle according to claim 1, wherein said projections are concave.

12. The axle according to claim 1, wherein said projections include a concave portion adjacent to said axle shaft and a tubular portion extending from said concave portion.

13. A vehicle drive axle comprising:
a housing defining a cavity having upper and lower portions;
oil collected in said lower portion;
an axle shaft having an outer generally cylindrical surface supported for a rotation within said cavity; and
a plurality of spaced apart noncontiguous projections extending from said outer surface of said axle shaft toward said housing.

14. The axle according to claim 13, wherein said projections are staggered radially about said outer surface and spaced laterally along a length of said axle shaft.

15. The axle according to claim 13, wherein said projections are flat.

16. The axle according to claim 13, wherein said projections are concave.

17. The axle according to claim 13, wherein said projections include a concave portion adjacent to said axle shaft and a two-door portion extending from said concave portion.
